(19) United States
(12) Patent Application Publication
(10) Pub. No.: US 2010/0037040 A1
(43) Pub. Date: Feb. 11, 2010

(54) METHOD AND APPARATUS FOR IMPLEMENTING VIRTUAL ENVIRONMENT

(75) Inventor: Wei-Ling Hsieh, Beijing (CN)

Correspondence Address: KNOBBE MARTENS OLSON & BEAR LLP, 2040 MAIN STREET, FOURTEENTH FLOOR, IRVINE, CA, 92614, US

(73) Assignee: Eunovation Int'l Limited, Hong Kong (CN)

(21) Appl. No.: 12/274,230

(22) Filed: Nov. 19, 2008

(30) Foreign Application Priority Data
Aug. 11, 2008 (CN) 200810133363.7

(51) Int. Cl. G06F 9/54; G06F 9/24

(52) U.S. Cl. 713/1; 719/331

(57) ABSTRACT

A method and apparatus for implementing virtual environment comprises: obtaining an operating instruction sent for executing an application program requiring to invoke the first dynamic link library (DLL) file, wherein the operating instruction carries a destination file position information; before the operating instruction is executed, inserting the destination file position information modification instruction sent for modifying the destination file position information requiring to make it invoke the second DLL file, and generating a virtual operating instruction; and executing the virtual operating instruction and orderly invoking the second DLL file and the first DLL file. The present invention implements the portability of application programs, system configuration information and private files in user mode, ensure the compatibility between the application programs and system configuration information of the OS and the stability of the OS under the precondition of not modifying the application programs and OS, and improve the efficiency of running the VOS.

### CROSS-REFERENCE TO RELATED APPLICATIONS

This application claims priority to Chinese Patent Application No. 200810133363.7, filed on Aug. 11, 2008, entitled “Method and Apparatus for Implementing Virtual Environment”, which is incorporated herein by reference in its entirety.

### FIELD OF THE TECHNOLOGY

This application relates to a field of computer technology, especially to a method and apparatus for implementing virtual environment (VE).

### BACKGROUND OF THE INVENTION

An operating system (OS) is a set of system software for controlling the running of other programs, managing system resources and providing users with operation interface. An OS can store a user's personalized system configuration information, application programs, and private files. In order to use the application programs and edit the private files in a familiar operating environment, the user usually needs to carry his own laptop computer. Although it is a laptop computer, its own weight and bulk still become a big burden for the user's daily journey. With continuous progress of technology, simulation for an operating environment becomes possible. A user can store some of the system configuration, application programs and private files into a mobile storage device so as to regenerate the operating environment simply by connecting the carried mobile storage device to schools, Internet Cafes, offices, or other places.

FIG. 1 is a schematic view illustrating the structure of a virtual OS implemented in prior art. As show in FIG. 1, the virtual OS (VOS) in prior art screens the computer's OS mainly through lightweight virtual machine software so as to prevent the application programs under running from directly contacting with the OS. Difference of every computer's setting and configuration results in that the application programs carried in the mobile storage device can not correctly run in every computer's OS and the OS can not correctly obtain the system configuration information carried in the mobile storage device for configuring itself. In order to solve the problem of compatibility between the OS and the carried application programs and system configuration information in the VOS, there are two conventional methods as follows:

The first method is to modify the application programs, that is, the manufacturer of the application programs has to rewrite the program section in an application program which is associated with the OS or hardware so as to make the application program under running completely break away from the OS and only depend on the VOS. The disadvantage of this method is that most application program manufacturers are not willing to cooperate with the VOS manufacturer for modifying the application program. Only a quite small number of application programs can be compatible with the VOS. The commonly used application programs, such as Microsoft Office, Adobe Photoshop, etc, can not run under such a VOS.

The second method is to modify the OS, that is, according to the requirement for running in a VOS, the OS is modified so as to achieve portability of the application programs and the system configuration information. The disadvantage of this method is that the modification can only be performed in kernel mode but can not be performed in user mode. However, the modification on the kernel of the OS may cause instability of the OS. Besides, most public PCs run in user mode, not kernel mode, which makes this method infeasible.

### SUMMARY OF CERTAIN INVENTIVE ASPECTS

One embodiment provides a method and apparatus for implementing virtual environment in order to implement the portability of application programs, system configuration information and private files in user mode, ensure the compatibility between the application programs and system configuration information of the OS and improve the stability of the OS under the precondition of not modifying the application programs and OS.

Another embodiment provides a method for implementing virtual environment. The method comprises:
obtaining an operating instruction sent for executing an application program requiring to invoke a first dynamic link library (DLL) file, wherein the operating instruction carries a destination file position information;
before the operating instruction is executed, inserting the destination file position information modification instruction sent for modifying the destination file position information requiring to invoke a second DLL file, and generating a virtual operating instruction; and
executing the virtual operating instruction and orderly invoking the second DLL file and the first DLL file.

A certain embodiment provides an apparatus for implementing virtual environment. The apparatus comprises:
an obtaining module adapted to obtain an operating instruction sent for executing an application program requiring to invoke a first dynamic link library (DLL) file, wherein the operating instruction carries a destination file position information;
an interpolation module adapted to, before the operating instruction is executed, inserting the destination file position information modification instruction sent for modifying the destination file position information requiring to invoke a second DLL file, and generating a virtual operating instruction; and
an executing module adapted to execute the virtual operating instruction and orderly invoke the second DLL file and the first DLL file.

It can be seen from the above technical solution, in the above embodiments, by storing the VOS into user-mode memory space and inserting the destination file position information modification instruction before the operating instruction, the operation of the application program jumps to execute the destination file position information modification instruction, modifies the pointing direction of the destination file position information to be the destination file in the virtual environment, and continues to executing the operating instruction hereafter so as to implement the portability of the application programs, system configuration information and private files under the user mode, ensure the compatibility between the application programs and system configuration information of the OS and the stability of the OS under the precondition of not modifying the application programs and OS, and improve the efficiency of running the VOS.

Certain embodiments will be described in more detail with reference to the drawings and the detailed description.

### BRIEF DESCRIPTION OF THE DRAWINGS

FIG. 1 is a schematic view illustrating the structure of a virtual OS implemented in prior art;

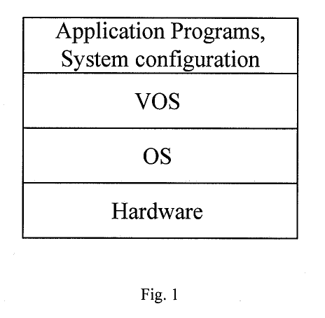

FIG. 2 is a flowchart illustrating the method for implementing virtual environment according to a first embodiment;

FIG. 3 is a flowchart illustrating the method for implementing virtual environment according to a second embodiment;

FIG. 4 is a structure schematic view illustrating the apparatus for implementing the virtual environment according to another embodiment.

### DETAILED DESCRIPTION OF PREFERRED EMBODIMENTS

In an embodiment, the VOS is stored into user-mode memory space and a destination file position information modification instruction is inserted before the operating instruction to modify the destination file position information so as to make it point at the destination file in the VOS. Then, the operating instruction continues to be executed so as to implement the portability of application programs, system configuration information and private files in user mode, ensure the compatibility between the application programs and system configuration information of the OS and the stability of the OS under the precondition of not modifying the application programs and OS, and improve the efficiency of running the VOS.

The method for implementing virtual environment according to one embodiment comprises:
obtaining an operating instruction sent for executing an application program requiring to invoke a first dynamic link library (DLL) file, wherein the operating instruction carries a destination file position information;
before the operating instruction is executed, inserting the destination file position information modification instruction sent for modifying the destination file position information requiring to invoke a second DLL file, and generating a virtual operating instruction; and
executing the virtual operating instruction and orderly invoking the second DLL file and the first DLL file.

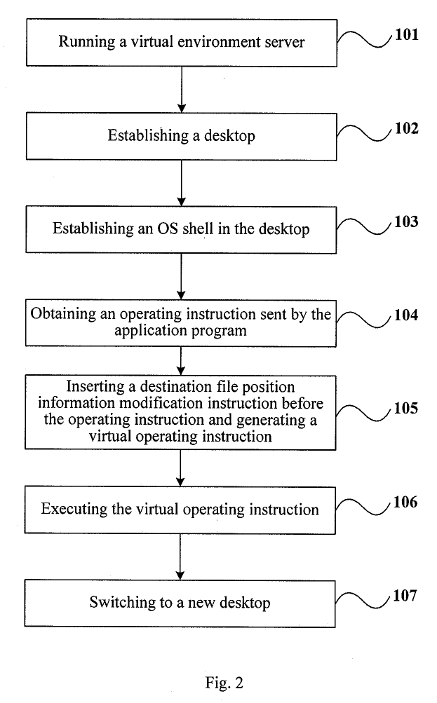

FIG. 2 is a flowchart illustrating the method for implementing virtual environment according to a first embodiment. As shown in FIG. 2, the present embodiment may comprise the following steps:

Step 101: running a virtual environment server.

The virtual environment server may manage the virtual environment. When every application program is running, the virtual environment server mainly hooks a VOS to the application program. The virtual environment server may be stored in a mobile storage device or in a medium whose program codes are not stored in local host such as a network side server.

After the storage medium stored with the virtual environment server is connected to the OS, the virtual environment server can automatically run to hook a VOS to every application program in the OS.

Step 102: establishing a desktop.

After the virtual environment server runs, every desktop in the OS will establish a desktop of its own. The desktop is an empty picture.

Step 103: establishing an OS shell in the desktop.

The explorer in the OS establishes an OS shell in the newly established desktop. The virtual environment server will hook a VOS to the OS shell.

The VOS is a program for simulating the OS. When the application program is running, the virtual environment server can hook the VOS into the application program, i.e. store the VOS into user mode memory space of a application program which corresponds to the VOS one by one.

Step 104: obtaining an operating instruction sent by the application program.

The application program may be software installed in the OS and may also be software stored in the mobile storage device. The operating instruction may be an application programming interface (API) in the OS.

Further more, the API may contain destination file position information to be checked or edited by the application program. The destination file position information points at the destination file, i.e. the virtual position of the destination file which can be seen in the virtual environment.

The destination file invoked in the virtual environment may be an executable file, an audio file, a video file or a document file such as all forms of files with a format of “.exe”, “.doc”, “.wma” or “.mp4”. In order to implement editing under the virtual environment, the file may carry the corresponding application program under the virtual environment such as an application program of Microsoft Office, media player and so on. The destination file may be a file stored in a computer readable storage medium (comprising hardware) or may be a file stored in a mobile storage device. Under the virtual environment, the virtual position of the destination file contained in the API needed for running the application program may point at a computer readable storage medium (comprising hardware) or may point at a mobile storage device.

Further more, the destination file may be stored in the OS or may be stored in a storage medium such as a mobile storage device or a server on the Internet.

For example, after a desktop is established in the OS and an OS shell is established in the desktop, the application program invokes the DLL file in the system through the API. The API contains the destination file position information to be checked or edited by the application program. The destination file position information points at the virtual position of the destination file, i.e. the position of the destination file seen by the user in the interface of the virtual environment. The destination file may be stored in a computer readable storage medium (comprising hardware) or may be stored in a mobile storage device. After the application program sending out the API, the VOS obtains the API at the moment while the API is entering the entrance of the DLL.

Step 105: inserting a destination file position information modification instruction before the operating instruction and generating a virtual operating instruction.

In the virtual environment, whenever the application program is executed, a VOS will be hooked. The VOS inserts the destination file position information modification instruction before the operating instruction sent by the application program and generates the virtual operating instruction. The destination file position information modification instruction invokes the second DLL file to modify the destination file position information. The operating instruction invokes the first DLL file for the application program to check or edit the destination file in the virtual position.

The second DLL file is one or more DLL files for modifying the virtual position of the destination file to be check or edited in the operating instruction. For example, in the virtual operating environment, the user wants to open a picture file named IMAGE in a disk driver “C:” in the OS. However, the picture file named IMAGE is actually stored in a mobile storage device whose disk driver symbol is “U:”. Then the user double clicks the picture file named IMAGE in the disk driver “C:” in the virtual environment to check the application program of the picture. For example, ACDsee software invokes the corresponding DLL file through the API to implement the opening operation on the picture file named IMAGE. At this moment, the destination file position information of the picture file IMAGE in the API is “C:\IMAGE”. Before the API invokes the DLL file, the VOS inserts a destination file position information modification instruction before the API operating instruction. The destination file position information modification instruction invokes the second DLL file to modify the destination file position information of the picture file IMAGE so as to modify the destination file position information of the picture file IMAGE in the API to be “U:\IMAGE”.

After inserting the destination file position information modification instruction, the VOS can continue to execute the operating instruction.

Further more, VOS orderly arranges the destination file position information modification instruction and the operating instruction of the application program in the user mode memory space and generates the corresponding virtual operating instruction.

Step 106: executing the virtual operating instruction.

VOS inserts a destination file position information modification instruction before the operating instruction sent by the application program and generates the virtual operating instruction.

The destination file position information modification instruction invokes the second DLL file to modify the destination file position information. The operating instruction invokes the first DLL file for the application program to check or edit the destination file of the virtual position.

Therefore, the step of executing the virtual operating instruction is actually orderly invoking the second DLL file and the first DLL file.

For example, when executing the virtual operating instruction, the VOS modifies the destination file position information carried in the operating instruction through the destination file position information modification instruction, i.e. modifies the storage path of the picture file IMAGE recorded in previous step from “C:\IMAGE” to “U:\IMAGE”, and then continues to execute the operating instruction. Through the operation of two instructions, the application program opens the picture IMAGE from the path of “U:\IMAGE” and may check or edit the destination file.

Further more, regarding the step of inserting a destination file position information modification instruction before the operating instruction, the VOS may insert one or more DLL files before the operating instruction to modify the destination file position information so as to enable the application program to be compatible with the OS.

Step 107: switching to a new desktop.

In the present embodiment, by storing the VOS into the user mode memory space and inserting the destination file position information modification instruction before the operating instruction, the operation of the application program jumps to execute the destination file position information modification instruction, modifies the pointing direction of the destination file position information to be the destination file in the virtual environment, and continues to executing the operating instruction hereafter so as to implement the portability of the application programs, system configuration information and private files under the user mode, ensure the compatibility between the application programs and system configuration information and the OS and the stability of the OS under the precondition of not modifying the application programs and OS, and improve the efficiency of running the VOS.

Further more, when the application program performs any operation in the virtual environment, the method for implementing virtual environment in this embodiment will repeat all the steps in the present embodiment so as to facilitate the VOS to modify the operating instruction sent by the application program and enable the application program to be compatible with the OS comprehensively.

Further more, in the present embodiment, after the step 103 is executed; the virtual environment may directly jump to execute the step 106 according to user's needs.

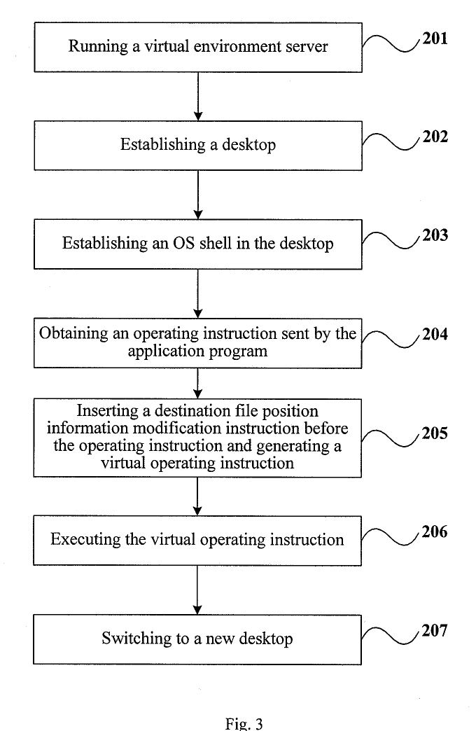

FIG. 3 is a flowchart illustrating the method for implementing virtual environment according to a second embodiment. As shown in FIG. 3, this embodiment may comprise the following steps:

Step 201: running the virtual environment server;

The virtual environment server may manage the virtual environment. When every application program is running, the virtual environment server mainly hooks a VOS to the application program. The virtual environment server may be stored in a mobile storage device or in a medium whose program codes are not stored in local host such as a network side server.

After the storage medium stored with the virtual environment server is connected to the OS, the virtual environment server can automatically run responsible for hooking a VOS to every application program in the OS.

Step 202: establishing a desktop.

After the virtual environment server runs, every desktop in the OS will establish a desktop of its own. The desktop is an empty picture.

Step 203: establishing an OS shell in the desktop.

The explorer in the OS establishes an OS shell in the newly established desktop. The virtual environment server will hook a VOS to the OS shell.

The VOS is a program for simulating the OS. When the application program is running, the virtual environment server can hook the VOS into the application program, i.e. store the VOS into the user mode memory space of a application program which corresponds to the VOS one by one.

Step 204: obtaining an operating instruction sent by the application program.

The application program may be software installed in the OS and may also be software stored in the mobile storage device. The operating instruction may be an application programming interface (API) in the OS.

Further more, the API may contain the destination file position information where the application program is going to store the destination file. The destination file position information points at the virtual position where the destination file is going to be stored. The destination file position information may be the virtual position where the destination file is stored, which can be seen in the virtual environment.

Further more, the DLL file can provide a plurality of application programs to share the codes and data thereof. The DLL file can execute the invoking when the hook program filters the system message and support the OSs with different configuration environment.

The destination file stored in the virtual environment may be an executable file, an audio file, a video file or a document file such as all forms of files with a format of “.exe”, “.doc”, “.wma” or “.mp4”. The destination file may be stored in the virtual environment. The destination file may be a file stored in a computer readable storage medium (comprising hardware) or may be a file stored in a mobile storage device. Under the virtual environment, the virtual position of the destination file contained in the API needed for running the application program may point at a computer readable storage medium (comprising hardware) or may point at a mobile storage device.

Further more, the destination file may be stored in the OS or may be stored in a storage medium such as a mobile storage device or a network side server.

For example, after a desktop is established in the OS and an OS shell is established in the desktop, the application program invokes the DLL file in the system through the API. The API contains the destination file position information to be stored by the application program. The destination file position information points at the virtual position of the destination file, i.e. the position of the destination file seen by the user in the interface of the virtual environment. The destination file may be stored in a computer readable storage medium (comprising hardware) or may be stored in a storage medium such as a mobile storage device or a network side server. After the application program sending out the API, the VOS obtains the API at the moment while the API is entering the entrance of the DLL.

Step 205: inserting a destination file position information modification instruction before the operating instruction and generating a virtual operating instruction.

In the virtual environment, whenever the application program is executed, a VOS will be hooked. The VOS inserts the destination file position information modification instruction before the operating instruction sent by the application program and generates the virtual operating instruction. The destination file position information modification instruction invokes the second DLL file to modify the destination file position information. The operating instruction invokes the first DLL file for the application program to store the destination file in the virtual position.

The second DLL file is one or more DLL files for modifying the virtual position of the destination file to be stored in the operating instruction. For example, in the virtual operating environment, the user wants to store a picture file named IMAGE into a disk driver “C:” in the OS. The application program invokes corresponding DLL file through the API to implement the storing operation on the picture file named IMAGE. At this moment, the destination file position information of the picture file IMAGE in the API is “C:\IMAGE”. Before the API invokes the DLL file, the VOS inserts a destination file position information modification instruction before the API operating instruction. The destination file position information modification instruction invokes the second DLL file to modify the destination file position information of the picture file IMAGE so as to modify the destination file position information of the picture file IMAGE in the API to be “U:\IMAGE”.

After inserting the destination file position information modification instruction, the VOS can continue to execute the operating instruction.

Further more, VOS orderly arranges the destination file position information modification instruction and the operating instruction of the application program in the user mode memory space and generates the corresponding virtual operating instruction.

Step 206: executing the virtual operating instruction.

VOS inserts a destination file position information modification instruction before the operating instruction sent by the application program and generates the virtual operating instruction.

The destination file position information modification instruction invokes the second DLL file to modify the destination file position information. The operating instruction invokes the first DLL file for the application program to store the destination file of the virtual position.

Therefore, the step of executing the virtual operating instruction is actually orderly invoking the second DLL file and the first DLL file.

For example, when executing the virtual operating instruction, the VOS modifies the destination file position information carried in the operating instruction through the destination file position information modification instruction, i.e. modifies the destination storage path of the picture file IMAGE recorded in previous step from “C:\IMAGE” to “U:\IMAGE”, and then continues to execute the operating instruction. Through the operation of two instructions, the application program stores the picture IMAGE to the “U:\IMAGE”.

Further more, regarding the step of inserting a destination file position information modification instruction before the operating instruction, the VOS may insert one or more DLL files before the operating instruction to modify the destination file position information so as to enable the application program to be compatible with the OS.

Step 207: switching to a new desktop.

In the present embodiment, by storing the VOS into the user mode memory space and inserting the destination file position information modification instruction before the operating instruction, the operation of the application program jumps to execute the destination file position information modification instruction, modifies the pointing direction of the destination file position information to be the destination file in the virtual environment, and continues to executing the operating instruction hereafter so as to implement the portability of the application programs, system configuration information and private files under the user mode, ensure the compatibility between the application programs and system configuration information of the OS and the stability of the OS under the precondition of not modifying the application programs and OS, and improve the efficiency of running the VOS.

Further more, when the application program performs any operation in the virtual environment, the method for implementing virtual environment in this embodiment will repeat all the steps in the present embodiment so as to facilitate the VOS to modify the operating instruction sent by the application program and enable the application program to be compatible with the OS comprehensively.

Further more, in the present embodiment, after the step 203 is executed; the virtual environment may directly jump to execute the step 206 according to user's needs.

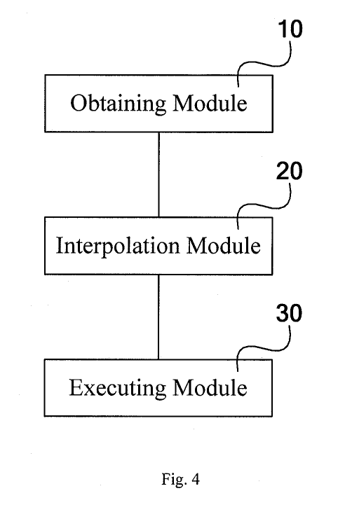

FIG. 4 is a structure schematic view illustrating the apparatus for implementing the virtual environment according to another embodiment. As shown in FIG. 4, this embodiment may comprise an obtaining module 10, an interpolation module 20 and an executing module 30 which are connected orderly. The obtaining module 10 is adapted to obtain an operating instruction sent for executing an application program requiring to invoke the first DLL file, wherein the operating instruction carries a destination file position information;, The interpolation module 20 is adapted to, before the operating instruction is executed, inserting the destination file position information modification instruction sent for modifying the destination file position information requiring to invoke the second DLL file, and generating a virtual operating instruction; The executing module 30 is adapted to execute the virtual operating instruction and orderly invoke the second DLL file and the first DLL file.

The present embodiment may execute the flows of methods for implementing virtual environment of the first embodiment and the second embodiment in accordance with the present invention.

The application program may be software installed in the OS and may also be software stored in the mobile storage device. The operating instruction may be an API in the OS. The destination file may be stored in the OS or may be stored in a storage medium such as a mobile storage device or a network side server. No matter whether the virtual position of the destination file in the virtual environment points at the path where the destination file is actually stored, the VOS will certainly insert a destination file position information modification instruction before the operating instruction to modify the destination file position information.

In the virtual environment, whenever the application program is executed, a VOS will be hooked. After the application program sends out an operating instruction, the obtaining module obtains the operating instruction. The interpolation module inserts the destination file position information modification instruction before the operating instruction and generates a virtual operating instruction. The executing module orderly invokes the second DLL file to i modify the destination file position information and invokes the first DLL file for the application program to check or edit the destination file in the virtual position.

Further more, the apparatus for implementing virtual environment in the present embodiment may further comprise a running module, a desktop establishing module and a shell establishing module which are connected orderly. The shell establishing module is connected to the obtaining module. The running module is adapted to run the virtual environment server. The desktop establishing module is adapted to establish a desktop and the shell establishing module is adapted to establish an OS shell.

Further more, the apparatus for implementing virtual environment in the present embodiment may further comprise a switching module connected to the executing module. The switching module is adapted to switch to a new desktop.

In the present embodiment, the obtaining module obtains the operating instruction before the operating instruction invokes the first DLL file. The interpolation module inserts a destination file position information modification instruction before the operating instruction. The executing module orderly executes the destination file position information modification instruction and the operating instruction to modify the pointing direction of the destination file position information to be the destination file in the virtual environment, and continues to executing the operating instruction hereafter so as to implement the portability of the application programs, system configuration information and private files under the user mode, ensure the compatibility between the application programs and system configuration information of the OS and the stability of the OS under the precondition of not modifying the application programs and OS, and improve the efficiency of running the VOS.

People skilled in this art can understand that: the implementation of all or part of the steps in the above-mentioned method embodiments can be completed by hardware related to program instructions. The program may be stored in a computer readable storage medium. During running, the program executes the steps comprising the above-mentioned method embodiments. The storage medium comprises the various media which are able to store program codes such as ROM, RAM, diskette or compact disc, etc.

Finally, it should be understood that the above embodiments are only used to explain, but not to limit the technical solution of the invention. In despite of the detailed description of the invention with referring to above preferred embodiments, it should be understood that various modifications, changes or equivalent replacements can be made by those skilled in the art without departing from the spirit and scope of the invention and covered in the claims of the invention.

What is claimed is:

1. A method for implementing virtual environment, comprising: obtaining an operating instruction sent for executing an application program requiring to invoke a first dynamic link library (DLL) file, wherein the operating instruction carries a destination file position information;
before the operating instruction is executed, inserting the destination file position information modification instruction sent for modifying the destination file position information requiring to invoke a second DLL file, and generating a virtual operating instruction; and
executing the virtual operating instruction and orderly invoking the second DLL file and the first DLL file.

2. The method according to claim 1, wherein a virtual operating system (VOS) is stored in user-mode memory space of the application program.

3. The method according to claim 1, wherein the obtaining an operating instruction sent for executing an application program requiring to invoke a first DLL file comprises: before invoking the first DLL file, obtaining the operating instruction sent by the application program.

4. The method according to claim 3, before the obtaining an operating instruction sent for executing an application program requiring to invoke a first DLL file, further comprising:
running a virtual environment server;
establishing a desktop; and
establishing an operating system shell in the desktop.

5. The method according to claim 4, after the executing the virtual operating instruction, further comprising: switching to a new desktop.

6. The method according to claim 2, wherein the obtaining an operating instruction sent for executing an application program requiring to invoke the first DLL file comprises: before invoking the first DLL file, obtaining the operating instruction sent by the application program.

7. The method according to claim 6, before the obtaining an operating instruction sent for executing an application program requiring to invoke the first DLL file, further comprising:
running a virtual environment server;
establishing a desktop; and
establishing an operating system shell in the desktop.

8. The method according to claim 7, after the executing the virtual operating instruction, further comprising: switching to a new desktop.

9. An apparatus for implementing virtual environment, comprising:
an obtaining module adapted to obtain an operating instruction sent for executing an application program requiring to invoke a first dynamic link library (DLL) file, wherein the operating instruction carries a destination file position information;
an interpolation module adapted to, before the operating instruction is executed, inserting the destination file position information modification instruction sent for modifying the destination file position information requiring to invoke a second DLL file, and generating a virtual operating instruction; and
an executing module adapted to execute the virtual operating instruction and orderly invoke the second DLL file and the first DLL file.

10. The apparatus according to claim 9, further comprising:
a running module adapted to run a virtual environment server;
a desktop establishing module adapted to establish a desktop; and
a shell establishing module adapted to establish an operating system shell.

11. The apparatus according to claim 7, further comprising:
a switching module adapted to switch to a new desktop.
